(19) United States
(12) Patent Application Publication
(10) Pub. No.: US 2008/0080402 A1
(43) Pub. Date: Apr. 3, 2008

(54) METHOD AND APPARATUS FOR PROVIDING INTERNET SERVICE IN A COMMUNICATION SYSTEM

(75) Inventors: Deug-Ku Chang, Yongin-si (KR); Dae-Seok Kim, Seoul (KR); Young-Ky Kim, Seoul (KR); Joon-Ho Park, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/865,496

(22) Filed: Oct. 1, 2007

(30) Foreign Application Priority Data
Sep. 30, 2006 (KR) 96686/2006

(51) Int. Cl. H04L 12/46

(52) U.S. Cl. 370/270

(57) ABSTRACT

A method and apparatus for providing an Internet service by interacting between a network of a network operator and an Internet service network in a communication system are provided, in which a service interface server interfaces between the Internet service network and the network of the network operator, an application server of the Internet service network requests from the service interface server at least one of subscriber profile information and/or service profile information for a subscriber, and upon receipt from the service interface server for the request for the at least one information, a universal user profile server provides the requested profile information among registered subscriber information and service profile information.

### PRIORITY

This application claims priority under 35 U.S.C. §119(a) to a Korean Patent Application filed in the Korean Intellectual Property Office on Sep. 30, 2006 and assigned Serial No. 2006-96686, the entire disclosure of which is hereby incorporated by reference.

### BACKGROUND OF THE INVENTION

1. Field of the Invention

The present invention generally relates to a communication system. More particularly, the present invention relates to a method for providing a variety of multimedia services in a communication system using the Internet.

2. Description of the Related Art

The Broadband convergence Network (BcN) is a convergence of hybrid networks. In the BcN with an Internet Protocol (IP) Multimedia Subsystem (IMS)-based system and a soft switch-based system converged, for example, users can receive services only if they subscribe to the services provided on a system basis.

If a user subscribes to an IMS service, the user can receive the IMS service within an IMS service area but not in a system that does not support the IMS service.

### SUMMARY OF THE INVENTION

An aspect of exemplary embodiments of the present invention is to address at least the problems and/or disadvantages discussed above and to provide at least the advantages described below. Accordingly, an aspect of exemplary embodiments of the present invention is to provide a method for providing a multimedia service using subscriber profile information received from a network of a network operator in an Internet Service Provider (ISP).

Another aspect of exemplary embodiments of the present invention provides a method for providing a method for providing a multimedia service using service profile information received from a network of a network operator in an ISP.

In accordance with an aspect of exemplary embodiments of the present invention, there is provided a method for providing an Internet service in a communication system, in which a first server for interacting with an Internet service network is configured in a network of a network operator, a second server is configured for registering and managing at least one of subscriber profile information and service profile information, and the first server receives a request for at least one of the subscriber profile information and the service profile information from the Internet service network, acquires the profile information from the second server, and provides the acquired profile information to the Internet service network.

In accordance with another aspect of exemplary embodiments of the present invention, there is provided a method for registering information to provide an Internet service in a network of a network operator in a communication system, in which a message including at least one of subscriber profile information and service profile information is transmitted to a first server, and a response message indicating whether the profile information has been successfully registered is received from the first server.

In accordance with a further aspect of exemplary embodiments of the present invention, there is provided a method for acquiring profile information for providing an Internet service in an application server that provides the Internet service in a communication system, in which a profile request message including an IDentification (ID) of a user to receive the Internet service is transmitted to a first server, and a response message including profile information is received from the first server

In accordance with still another aspect of exemplary embodiments of the present invention, there is provided an apparatus for providing an Internet service by interacting between a network of a network operator and an Internet service network in a communication system, in which a service interface server interfaces between the Internet service network and the network of the network operator, an application server of the Internet service network requests at least one of subscriber profile information and service profile information for a subscriber to the service interface server, and upon receipt of the request for the information from the service interface server, a universal user profile server provides the requested profile information among registered subscriber information and service profile information.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 illustrates the concept of an interface between a network operator and ISPs according to an exemplary embodiment of the present invention;

FIG. 2 illustrates the configuration of a network in which an ISP receives subscriber profile information and service profile information from a network of a network operator according to an exemplary embodiment of the present invention;

FIG. 3 is a signal flow diagram for a provisioning procedure for registering subscriber profile information and service profile information according to an exemplary embodiment of the present invention;

FIG. 4 is a signal flow diagram for a procedure for acquiring subscriber profile information from a Universal User Profile Server (UUPS) in an Application Server (AS) of the ISP according to an exemplary embodiment of the present invention; and

FIG. 5 is a signal flow diagram for a procedure for acquiring service profile information from an AS of the network operator in the AS of the ISP according to an exemplary embodiment of the present invention.

Throughout the drawings, the same drawing reference numerals will be understood to refer to the same elements, features and structures.

### Detailed Description of Exemplary Embodiments

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a method for providing a variety of additional services using subscriber profile information and service profile information for a subscriber that has subscribed to a Broadband Convergence Network (BcN) in an Internet Service Provider (ISP).

In accordance with the present invention, the ISP receives the subscriber profile information and the service profile information from a Universal User Profile Server (UUPS) maintained and managed by a network operator via a Service Interface Server (SIS). The SIS is a server with an interfacing function required for interaction between a network of the network operator and an Internet service network.

After registration, the subscriber receives a service. For this purpose, an Operation Support System (OSS) can provide the service to the subscriber after a provisioning process in which the subscriber profile information and the service profile information for the subscriber are registered to other nodes.

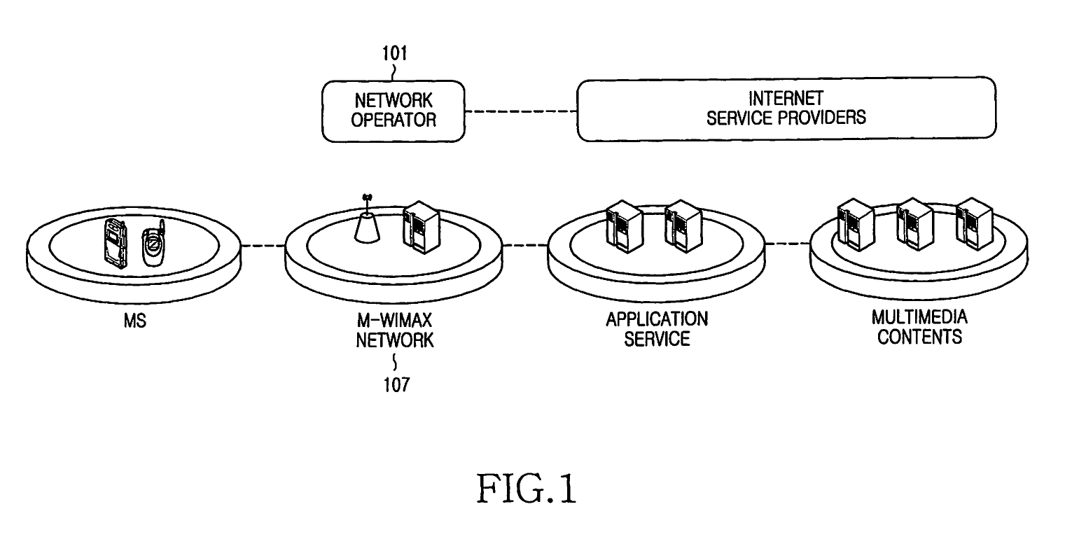

FIG. 1 illustrates the concept of an interface between a network operator and an ISP according to an exemplary embodiment of the present invention.

Referring to FIG. 1, the network operator 101 is a network infrastructure operator and the ISP is an organization that provides Internet access to subscribers, such as Yahoo and Google. In the illustrated case of FIG. 1, the network operator 101 has authorization to use subscriber profile information and/or service profile information. The ISP can receive the subscriber profile information and the service profile information from the network operator 101, while maintaining and managing application services and multimedia contents.

While it is shown that the network operator 101 operates a Mobile Worldwide Interoperability for Microwave Access (M-WiMAX) network 107 and the ISP interworks with the M-WIMAX network in FIG. 1, this is a mere exemplary application. The present invention is applicable to any other system such as Wideband Code Division Multiple Access (WCDMA), High Speed Downlink Packet Access (HSDPA), Long Term Evolution (LTE), and CDMA 2000-1x Data Only (DO).

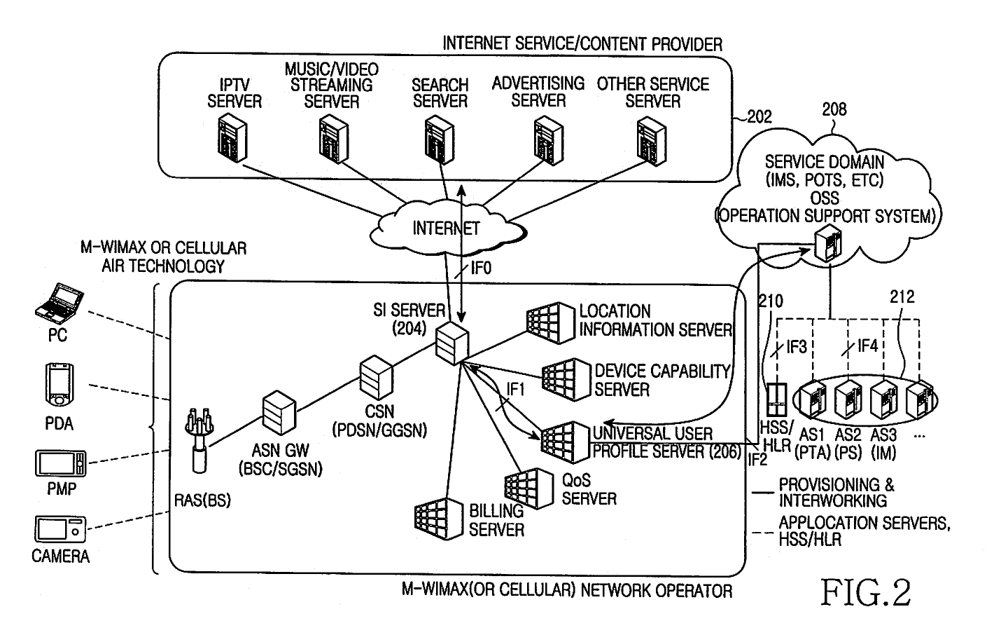

FIG. 2 illustrates the configuration of a network in which an ISP receives subscriber profile information and service profile information from a network of a network operator according to an exemplary embodiment of the present invention.

Referring to FIG. 2, the network includes subscriber terminals including Personal Computers (PCs), Personal Digital Assistants (PDAs), Personal Multimedia Players (PMPs), and cameras, servers and databases operated by the network operator, and servers 202, an OSS 208, and ASs associated with various services provided by the ISP.

In accordance with the present invention, there are servers for storing or using information about subscribers, terminals, and services. These servers are a location information server, a device capability server, a UUPS 206, a Quality of Service (QoS) server, and a billing server.

The location information server manages location information about subscribers and terminals and the device capability server manages device capability information about terminals, for example, information about the types, resolutions, operation systems, and Coder-Decoders (CODECs) of the terminals. The UUPS 206 manages information about hobbies, ages, addresses, etc. of the subscribers, and the QoS server determines and manages QoS levels of the subscribers and services. The billing server manages billing for services.

Particularly, the UUPS 206 manages subscriber profile information and service profile information and provides this information to an ISP network via the SIS 204.

With reference to FIG. 2, interfaces and a network configuration for receiving the subscriber profile information and the service profile information from the network of the network operator in the ISP will be described below.

An interface IFO is needed for interaction between the network of the ISP 202 and the SIS 204. IFO can be defined by the following protocol and functions.

Protocol: Secure Hypertext Transfer Protocol/eXtensible Markup Language (HTTPS/XML)

Functions:
content access authorization
user/device information retrieval
subscriber location information retrieval
QoS requirements enforcement
accounting information exchange
server triggered paging transaction

An interface IF1 interfaces between the SIS 204 and the UUPS 206. IF1 can be defined by the following protocol and functions.

Protocol: HTTPS/XML or Diameter/Radius

Functions:
service authentication/authorization request/response
service profile request/response
subscriber profile request/response
service information request/response

An interface IF2 interfaces between the UUPS 206 and the OSS 208. IF2 can be defined by the following protocol and functions.

Protocol: HTTPS/XML or Simple Object Access Protocol (SOAP)

Functions:
service provisioning request/response
service profile request/response
subscriber profile request/response
others

An interface IF3 interfaces between the OSS 208 and a Home Subscriber Server/Home Location Register (HSS/HLR) 210. IF3 can be defined by the following protocol and functions.

Protocol: Transmission Control Protocol/Internet Protocol (TCP/IP)-based protocol such as HTTPS/XML or Simple Object Access Protocol (SOAP)

Functions:
service provisioning request/response
service profile request/response
subscriber profile request/response

An interface IF4 interfaces between the OSS 208 and an AS 212. IF4 can be defined by the following protocol and functions.

Protocol: Transmission Control Protocol/Internet Protocol (TCP/IP)-based protocol such as HTTPS/XML or Simple Object Access Protocol (SOAP)

Functions:
subscriber provisioning request/response
subscriber profile request/response
service information request/response

The UUPS 206 may be configured separately or incorporated into another server.

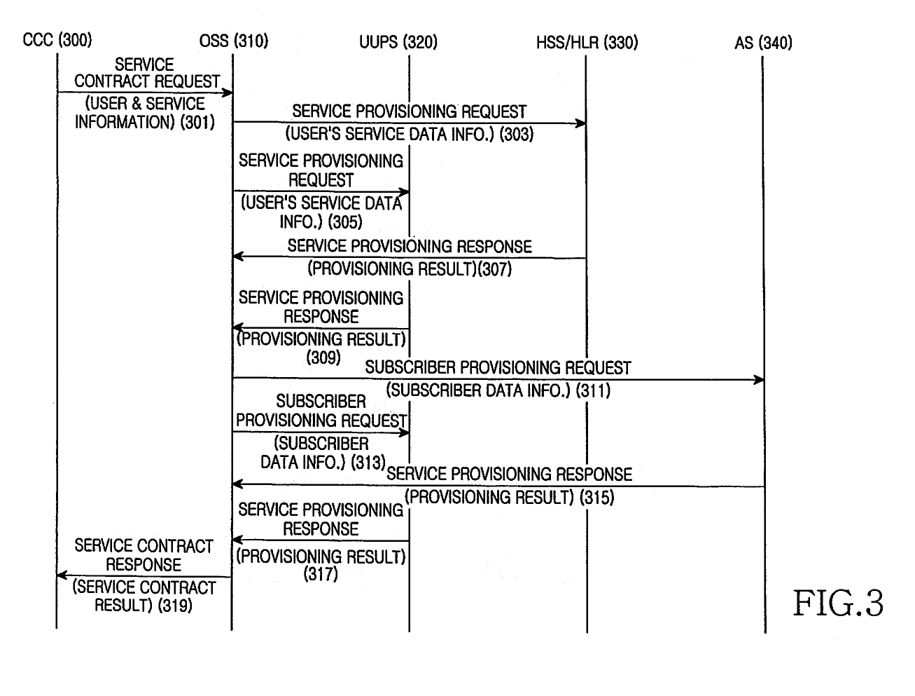

FIG. 3 is a signal flow diagram for a provisioning procedure for registering subscriber profile information and service profile information according to an exemplary embodiment of the present invention.

Referring to FIG. 3, to subscribe to the network of the network operator, a subscriber registers his subscriber information and service information about an intended service with a Customer Care Center (CCC) 300 by visiting the CCC or through a web portal.

In step 301, the CCC 300 transmits subscriber profile information and service profile information corresponding to the registered subscriber information and service information to an OSS 310 by a Service Contract Request message.

The OSS 310 in step 303 transmits a Service Provisioning Request message including the service profile information (User's Service Data Info) to an HSS/HLR 330. The OSS 310 in step 305 also transmits the Service Provisioning Request message to a UUPS 320.

In steps 307 and 309, the OSS 320 receives Service Provisioning Response messages with provisioning results, that is, information indicating whether the service profile information has been registered normally from the UUPS 320 and the HSS/HLR 330.

To provide the subscriber-requested service, the OSS 310, the UUPS 320, and an AS 340 in steps 311 to 319 perform a provisioning request and response procedure associated with the subscriber profile information.

The OSS 310 transmits a Subscriber Provisioning Request message including the subscriber profile information (Subscriber Data Info) to the AS 340 in step 311 and to the UUPS 320 in step 313.

In steps 315 and 317, the OSS 310 receives Subscriber Provisioning Response messages with provisioning results, that is, information indicating whether the subscriber profile information has been registered normally from the UUPS 320 and the HSS/HLR 330. In step 319, the OSS 310 transmits a Service Contract Response message including a service contract result to the CCC 300.

As described above, the provisioning associated with the subscriber profile information is separately performed from the provisioning associated with the service profile information in FIG. 3. The UUPS 320 is more a physical device added to serve the ISP than a physical device subordinate to the network of the network operator. Therefore, it is preferred that the UUPS 320 is configured separately from the HSS/HLR 330 although the two entities are similar in that they manage subscriber profile information.

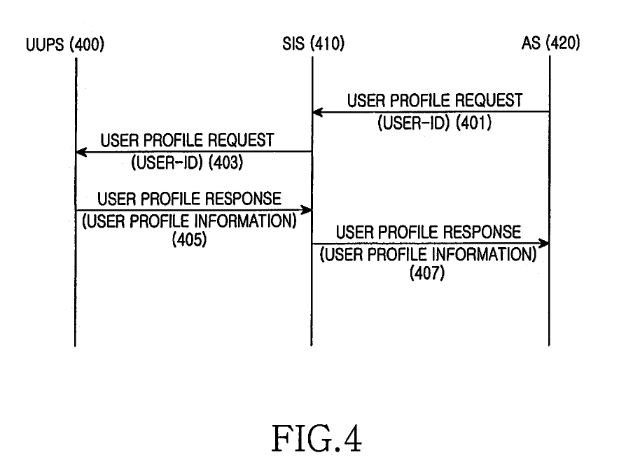

FIG. 4 is a signal flow diagram for a procedure for acquiring subscriber profile information from the UUPS in an AS of the ISP according to an exemplary embodiment of the present invention.

Referring to FIG. 4, upon receipt of a request for a particular service from a subscriber, an AS 420 transmits in step 410 a User Profile Request message including a User-Identification (ID) to an SIS 410 of the network of the network operator. It is to be noted that the AS 420 is an AS operated by the ISP, unlike the AS 340 illustrated in FIG. 3.

The SIS 410 in step 403 forwards the User Profile Request message to a UUPS 400. The UUPS 400 transmits in step 405 a User Profile Response message including subscriber profile information corresponding to the user-ID to the SIS 410. In step 407, the SIS 410 transmits the received User Profile Response message to the AS 420. Then the AS 420 provides the service to the subscriber based on the subscriber profile information.

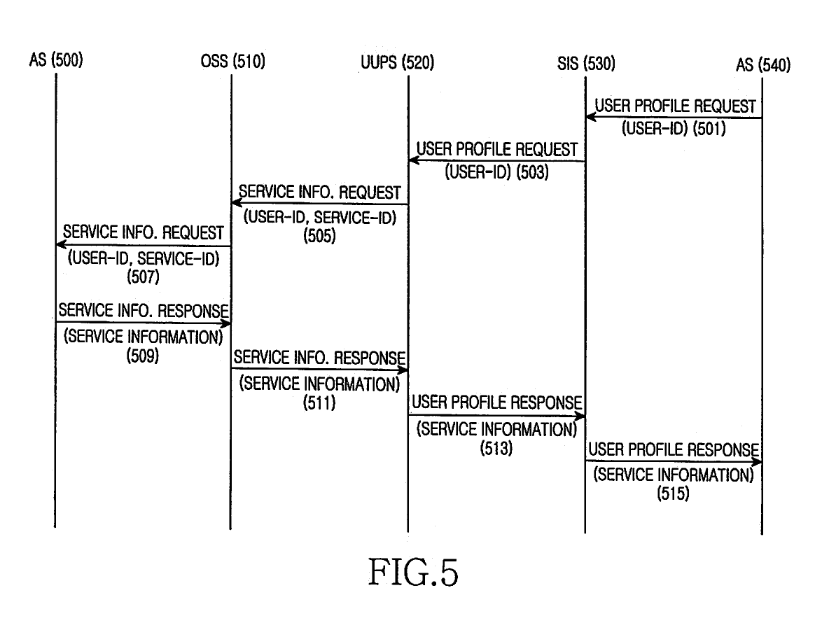

FIG. 5 is a signal flow diagram for a procedure for acquiring service profile information from an AS of the network operator in an AS of the ISP according to an exemplary embodiment of the present invention.

Referring to FIG. 5, in step 501 an AS 540 of the ISP transmits a User Profile Request message including a User-ID to an SIS 530. The SIS 530 in step 530 forwards the User Profile Request message to a UUPS 520. The UUPS 520 transmits in step 505 a Service Info Request message including the user-ID and a Service-ID to an SIS 510. The Service-ID identifies a particular application service provided by a particular AS. Therefore, the Service-ID identifies an AS, herein an AS 500.

In step 507, the SIS 510 transmits the received Service Info Request message to the AS 500 of the network operator. The AS 500 transmits in step 509 a Service Info Response message to the SIS 510. The Service Info Response message includes service profile information.

In step 511, the OSS 510 transmits the Service Info Response message to the UUPS 520. The UUPS 520 transmits in step 513 a User Profile Response message including the service profile information to the SIS 530. The SIS 530 transmits in step 515 the User Profile Response message to the AS 540 of the ISP.

As is apparent from the above description, the exemplary embodiments of the present invention enable an ISP to use subscriber profile information and service profile information maintained and managed in a network of a network operator, so that the network operator and the ISP can maximize their profits. Also, subscribers to Internet service can receive a variety of services over the Internet.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for providing an Internet service in a communication system, comprising:
configuring a first server that can interact with an Internet service network in a network of a network operator;
configuring a second server for registering and managing at least one of subscriber profile information and/or service profile information;
receiving by the first server a request for at least one of the subscriber profile information and/or the service profile information from the Internet service network;
acquiring by the first server the profile information from the second server; and
providing by the first server the acquired profile information to the Internet service network.

2. The method of claim 1, wherein the first server is a service interface server for providing a function required for interacting between the Internet service network and the network of the network operator.

3. The method of claim 1, wherein the second server is a universal user profile server.

4. A method for registering information to provide an Internet service in a network of a network operator in a communication system, comprising:
transmitting to a first server a message including at least one of subscriber profile information and/or service profile information; and
receiving from the first server a response message indicating if the at least one profile information has been successfully registered.

5. The method of claim 4, wherein the first server is an application server operated in the network of the network operator, for providing an application service.

6. The method of claim 4, wherein the first server is a server operated in the network of the network operator, for providing the profile information to a second server towards an Internet service network.

7. The method of claim 6, wherein the second server is a service interface server for interfacing between the Internet service network and the network of the network operator.

8. A method for acquiring profile information for providing an Internet service in an application server that provides the Internet service in a communication system, comprising:
transmitting to a first server a profile request message including an Identification (ID) of a user to receive the Internet service; and
receiving the first server a response message including profile information from.

9. The method of claim 8, wherein the first server is a service interface server for interfacing between an Internet service network and a network of a network operator.

10. The method of claim 8, wherein the profile information is at least one of subscriber profile information and/or service profile information.

11. An apparatus for providing an Internet service by interacting between a network of a network operator and an Internet service network in a communication system, comprising:
a service interface server for interfacing between the Internet service network and the network of the network operator;
an application server in the Internet service network, for requesting at least one of subscriber profile information and/or service profile information for a subscriber to the service interface server; and
a universal user profile server for, upon receipt for the request for the at least one of the subscriber profile information and/or the service profile information from the service interface server, providing the requested profile information among registered subscriber information and service profile information.

12. The apparatus of claim 11, wherein at least one of Secure Hypertext Transfer Protocol (HTTPS), eXtensible Markup Language (XML) Diameter and Radius is used as a protocol between the service interface server and the application server.

13. The apparatus of claim 11, wherein at least one of HTTPS, XML, Diameter, Radius is used as a protocol between the service interface server and the universal user profile server.
